(19) United States
(12) Patent Application Publication
(10) Pub. No.: US 2005/0253363 A1
(43) Pub. Date: Nov. 17, 2005

(54) Flanigan trailer lock

(76) Inventor: John Maurice Flanigan, Bartlesville, OK (US)

Correspondence Address: John M. Flanigan, 1220 N. Ross, Dewey, OK, 74029, US

(21) Appl. No.: 10/843,997

(22) Filed: May 13, 2004

(51) Int. Cl. B60T 7/12

(52) U.S. Cl. 280/507

(57) ABSTRACT

I, John M. Flanigan, have invented a new locking device for bumper pull trailer couplers. A universal bumper pull trailer locking device that obstructs a trailer hitch coupling mechanism and prevents the attachment to the ball of a towing vehicle. The locking device slides over the coupler mechanism. The locking mechanism is moved to the closed position and a padlock is inserted into the hole provided for. The padlock is inside a canister and is protected from vandalism. The entire coupler is covered, preventing the trailer from being attached to an unauthorized vehicle. The locking device is simple, durable, effective, easy to use and fits multiple trailer couplers.

### BRIEF SUMMARY OF INVENTION

Universal bumper pull trailer locking device comprising of a canister which slides over a trailer coupler and plunger is raised into trailer coupler and padlock is inserted into hole provided for.

### BRIEF DESCRIPTION OF DRAWINGS

Part #1 Flat bar stock ⅛″×3″×5″

Part #2 1″ pipe 1½″

Part #3 ¼″×1½″×2½″ flat bar with ⅝″ hole

FIG. 1 Part #1, #2, #3 welded together to make plunger

Part #4 ⅝″ rod×1½

Part #5 ⅛″×4½″ pipe×7″ for bulldog hitches or ⅛″×5½″ pipe×7″ for couplers without bulldog hitches

FIG. 2 Front view open or loading position

FIG. 3 Side view open or loading position

FIG. 4 Front view closed position—ready to accept padlock

FIG. 5 Side view closed position—ready to accept padlock

### DETAILED DESCRIPTION OF THE INVENTION

As required embodiments of the present invention are disclosed herein; however, it is to be understood that the enclosed embodiments are merely exemplary of the invention, which may be embodied in various forms. Therefore, specific functional and structural details disclosed herein are not to be interpreted as limiting, but merely as a basis for this claim.

With the use of metal cutting tools and a vertical milling machine as shaping tools for the invention, it is constructed of metal (cold rolled steel). With the use of a welding machine the plunger is welded into place.

Referring to the drawing for more detail:

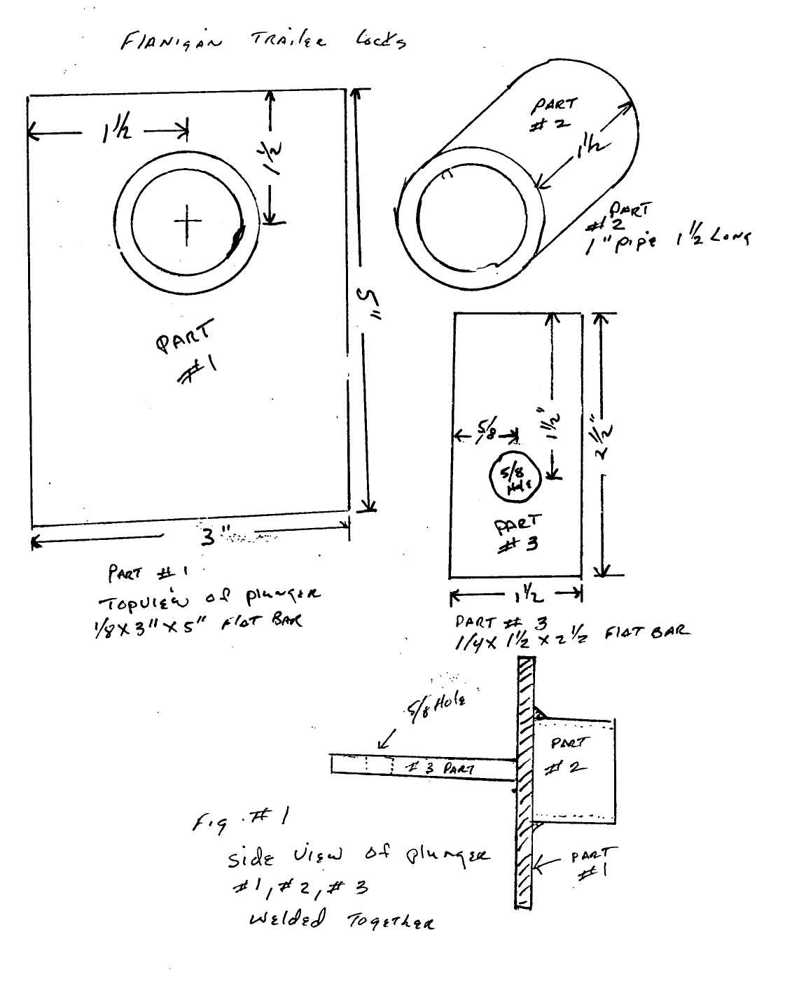

FIG. 1 generally shows parts #1, #2, and #3 welded together to form plunger.

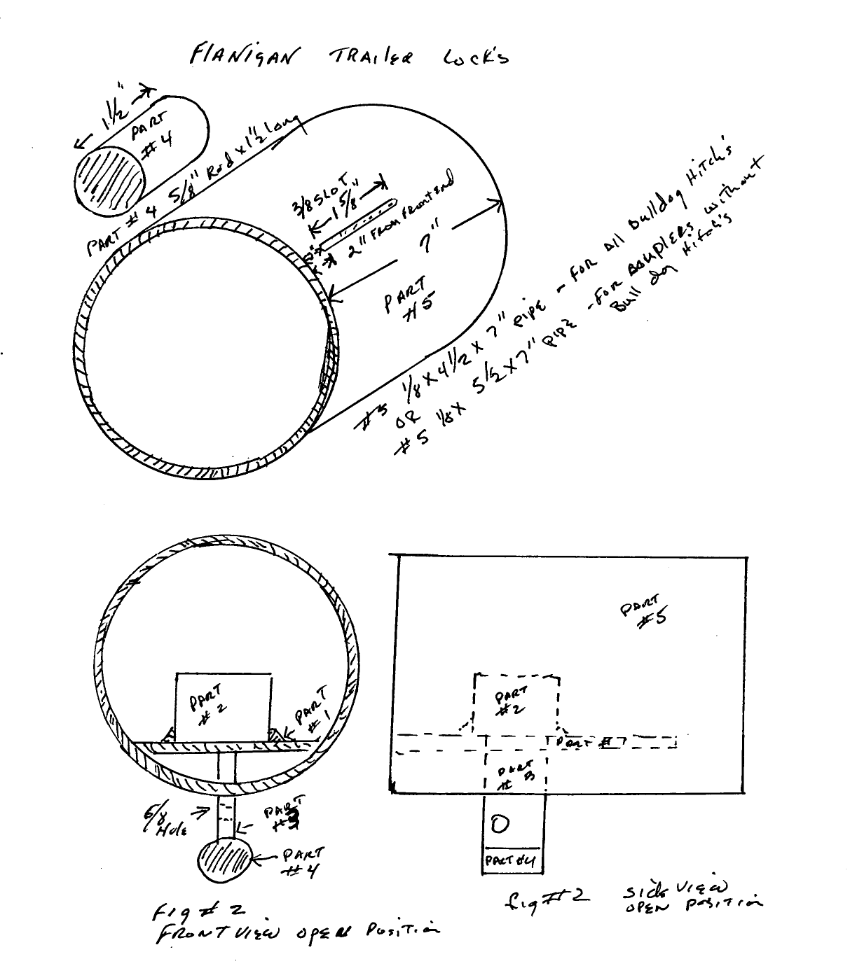

FIG. 2 shows plunger placed in canister part #5 and part #4 ⅝″ rod welded into place.

FIG. 3 discloses plunger in place in canister in open position.

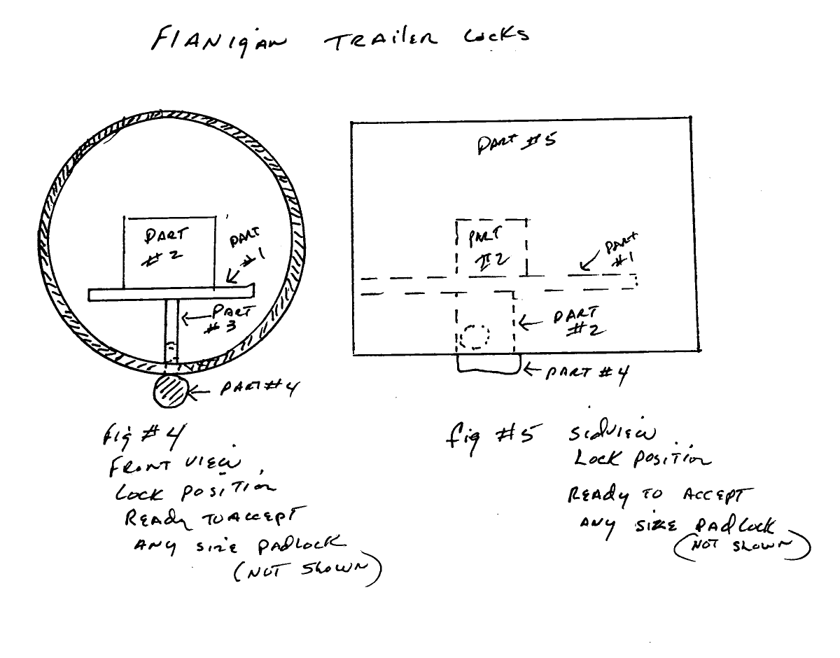

FIG. 4 discloses plunger in upright or locking position and ready to accept padlock.

FIG. 5 is side view of plunger in locking position ready to accept padlock.

Operation:

To lock: The assembled invention in FIG. 3 is slid over coupler, until plunger is lined up with trailer coupler. Then plunger is pushed up into trailer coupler and any size padlock is introduced to ⅝″ hole so as to have padlock between part #1 and inserted in hole of part #3 with canister and padlock keeping plunger from lowering.

To unlock: Insert the key to padlock and unlock, removing padlock, plunger drops down allowing removal of locking device.

It is to be understood that the present invention is not limited to the embodiment described above, but encompasses any and all embodiments within the scope of the claim.

1) a trailer locking device, comprised of said cylinder with one moveable plunger.

2) Said cylinder is inserted over trailer coupler and the moveable plunger is raised into trailer coupler to allow a padlock to be placed in a predrilled hole.

3) The plunger is designed to fit inside of coupler for any universal size ball fitting.

4) The plunger is designed to keep cylinder from being removed while padlock is in place.

5) With cylinder in place on trailer coupler, the trailer coupler protects padlock from being tampered with from above and cylinder protects padlock from being tampered with from below or front or back.
